(19) United States
(12) Patent Application Publication
(10) Pub. No.: US 2025/0192258 A1
(43) Pub. Date: Jun. 12, 2025

(54) RECYCLING AND RECOVERY OF USED LIQUEFIED GAS ELECTROLYTE AND BATTERY SALT, AND COMPOSITIONS OF FIRE-EXTINGUISHING ELECTROLYTES FOR BATTERIES

(71) Applicant: THE REGENTS OF THE UNIVERSITY OF CALIFORNIA, Oakland, CA (US)

(72) Inventors: Ying Shirley MENG, San Diego, CA (US); Yijie YIN, San Diego, CA (US); Yangyuchen YANG, San Diego, CA (US); Matthew MAYER, Binghamton, NY (US); Weikang LI, Bolingbrook, IL (US); Ganesh RAGHAVENDRAN, San Diego, CA (US); Zheng CHEN, San Diego, CA (US)

(21) Appl. No.: 18/843,096

(22) PCT Filed: Mar. 6, 2023
(86) PCT No.: PCT/US2023/063805

§ 371 Date: Aug. 30, 2024

Related U.S. Application Data
(60) Provisional application No. 63/268,910, filed on Mar. 4, 2022.

(51) Int. Cl. H01M 10/54; H01M 10/0525; H01M 10/0568; H01M 10/0569

(52) U.S. Cl. CPC H01M 10/54; H01M 10/0568; H01M 10/0569; H01M 10/0525

(57) ABSTRACT

Methods, materials, and devices that pertain to recycling liquefied gas electrolyte, recovering battery salt from spent battery materials and fire-extinguishing electrolytes for batteries are disclosed. In some embodiments of the disclosed technology, a device includes a first battery module including a first liquefied gas electrolyte, a second battery module structured to store a second liquefied gas electrolyte, a temperature controller configured to separately control a first temperature of the first battery module and a second temperature of the second battery module to evaporate the first liquefied gas electrolyte into a gas electrolyte and liquefy the gas into the second liquefied gas electrolyte, and a flow channel coupled between the first battery module and the second battery module to convey the gas electrolyte from the first battery module to the second battery module. For salt recycling technology, the salt from the spent battery materials is solvated using Me₂O under its vapor pressure and thus formed salt solution is separated. The salt from the recovered feed solution is extracted using heating/vacuum technology.

### CROSS-REFERENCE TO RELATED APPLICATION

This patent document claims priority to and benefits of U.S. Provisional Appl. No. 63/268,910, titled “RECYCLING LIQUEFIED GAS ELECTROLYTE AND COMPOSITIONS OF FIRE-EXTINGUISHING ELECTROLYTES FOR BATTERIES” and filed on Mar. 4, 2022. The entire contents of the before-mentioned patent application are incorporated by reference as part of the disclosure of this document.

### TECHNICAL FIELD

The invention relates to methods and devices for recycling liquefied gas electrolyte and recovery of battery salts from used materials, and fire-extinguishing electrolytes.

### BACKGROUND

The combination of high energy density, improved safety, environmental sustainability and wide temperature operation range is the ultimate goal when designing next-generation electrolytes for lithium-based secondary batteries. However, due to the inherently divergent nature of many of these metrics, the majority of electrolytes fail to satisfy the above requirements simultaneously.

### SUMMARY

The disclosed technology can be implemented in some embodiments to provide methods, materials and devices that pertain to recycling lithium salts, lithium contained additives liquefied gas electrolytes, fire-extinguishing electrolytes for batteries.

In some implementations of the disclosed technology, a device includes a first battery module including a first liquefied gas electrolyte; a second battery module structured to store a second liquefied gas electrolyte; a temperature controller coupled to the first battery module and to the second battery module and configured to separately control a first temperature of the first battery module and a second temperature of the second battery module to allow evaporation of the first liquefied gas electrolyte into a gas electrolyte and liquefication of the gas into the second liquefied gas electrolyte; and a flow channel coupled between the first battery module and the second battery module to convey the gas electrolyte from the first battery module to the second battery module.

In some implementations of the disclosed technology, a recycling method includes controlling the temperature of first battery module at high temperature/room temperature including a first liquefied gas electrolyte and coupled to, via a flow channel, second battery module structured to store recycled liquified gas electrolyte maintained at relatively reduced temperature; opening the flow channel to evaporate the first liquefied gas solvent into a gas phase, transfer the gaseous solvent to the second battery module; and controlling a second temperature of the second battery module to liquefy the gas received by the second battery module into the second liquefied gas electrolyte.

In some implementations of the disclosed technology, a method of separating and recycling electrolyte salts from used battery materials for lithium-ion batteries includes placing, in a container, used battery materials obtained from spent batteries or manufacturing scraps; applying dimethyl ether (Me₂O) gas at a vapor pressure to the container to solvate the used battery materials; and filtering the battery shreds and/or black mass to recover salt solution from which salt is then recovered at high temperature.

In some implementations of the disclosed technology, a device contained shredded batteries and/or black mass is connected to mass flow controller to fill the gas inside the device to recover lithium salts and lithium contained additives from the batteries shreds or black mass.

In some implementations of the disclosed technology, a recycling method includes controlling a first temperature of a first battery module, wherein the first battery module includes a first liquefied gas electrolyte and is coupled, via a flow channel, to a second battery module, opening the flow channel to evaporate the first liquefied gas electrolyte into a gas electrolyte, and to transfer the gas electrolyte to the second battery module, and controlling a second temperature of the second battery module to liquefy the gas received by the second battery module into a second liquefied gas electrolyte.

In some implementations of the disclosed technology, a recycling method of recycling electrolyte salts for lithium-ion batteries includes placing, in a container, spent battery materials obtained from spent batteries or manufacturing scraps, applying dimethyl ether (Me₂O) gas at a predetermined vapor pressure to the container to solvate salts used in the spent battery materials, and increasing a temperature of the container to obtain recycled battery materials.

The above and other aspects and implementations of the disclosed technology are described in more detail in the drawings, the description and the claims.

### BRIEF DESCRIPTION OF THE DRAWINGS

FIG. 1 is a schematic illustration of an electrolyte solvent recycle process based on some implementations of the disclosed technology.

FIG. 2 shows observation of liquefied gas solvents recycling from window cell.

FIG. 3 shows demonstration of recycling liquefied gas solvents in batteries.

FIGS. 4A-4C show salt solubility test−s of studied electrolytes at selected different temperatures.

FIG. 5 shows ionic conductivities of studied electrolytes from −78 to 80° C.

FIGS. 6A-6D show optical images of extinguishing ignited candle tests of different gases.

FIGS. 7A-7D show electrochemical performance of lithium metal anode and Li-NMC622 cells in liquefied gas electrolytes. FIGS. 7E-7G show Li-NMC622 charge and discharge at selected temperature for LGE, ether and carbonated electrolytes.

FIGS. 8A-8D show examples of liquefied gas electrolytes.

FIGS. 9A-9F show properties of liquefied gas electrolytes.

FIGS. 10A-10G show electrochemical performance of lithium metal anode and Li-NMC622 cells in liquefied gas electrolytes.

FIGS. 11A-11D show recycling concept and demonstration of liquefied gas electrolytes.

FIG. 12 shows the compositions of clean agent of FS 49 C2.

FIG. 13 shows solubility test on LiTFSI/LiFSI-Me₂O-TFE/PFE/HFP and pure Me₂O/TFE/HFP.

FIGS. 14A-14C show solubility test on 1 M LiFSI-Me₂O-TFE-PFE at different temperatures, +23° C., +60° C., and −78° C. FIG. 14D shows tailor Me₂O ratio to fully dissolve LiFSI at +23° C.

FIG. 15 shows fluorine atom molar ratio in different electrolytes.

FIG. 16 shows device setup for candle tests.

FIGS. 17A-17B show fire suppression tests of different pure gases TFE and PFE.

FIG. 18 shows optical images of lithium metals soaked in liquefied gas solvents and electrolytes for 14 days.

FIG. 19 shows Li-NMC622 voltage hold test in the liquefied gas electrolytes.

FIG. 20 shows long-term Li/NMC cycling at +55° C.

FIG. 21 shows transference number measurement of designed electrolyte.

FIG. 22 shows Li/NMC cycling at different current rate.

FIG. 23 shows summary of the global warming potential for different gases. Data are extracted from IPCC Second Assessment Report.

FIGS. 24A-24B show stable Li—X/Me₂O (X=FSI⁻/TFSI⁻/PF₆⁻/any anion) solvent preparation with Pᵥₐₚ at about 1 atm.

FIGS. 25A-25B show salt recovery curves of LiFSI in Me₂O based on mass and based on volume.

FIG. 26 shows an example of salt recovery circular system.

FIG. 27 shows an example method for solvent recycling based on some implementations of the disclosed technology.

FIG. 28 shows an example method of for solvent recycling based on some

implementations of the disclosed technology.

### DETAILED DESCRIPTION

Disclosed are compositions, materials, methods, articles of manufacture and devices that pertain to the use of fire-extinguishing liquefied gas electrolytes in batteries and/or recollecting liquefied gas solvent molecules for immediate reuse.

The disclosed technology can be implemented in some embodiments to use a transformative concept of using a variety of hydrofluorocarbon liquefied gas as the main solvents to circumvent the conventional liquid phase temperature window. The disclosed technology can be implemented in some embodiments to overcome the

flammability issues in the current electrolyte systems while maintaining stable long-term cycling and wide temperature operation from −80 to +60° C. and provide a route to sustainable, temperature resilient lithium metal batteries with unique fire-extinguishing properties that maintain state-of-the-art electrochemical performance.

Based on the compositions of clean fire extinguishing agents, the disclosed technology can be implemented in some embodiments to provide inherently safe liquefied gas electrolytes (LGE) based on 1,1,1,2-tetrafluoroethane (TFE) and pentafluoroethane (PFE) that maintain more than 3 mS cm⁻¹ ionic conductivity from −78 to +80° C. Benefiting from a solvation structure which limits parasitic reactivity, and a high bulk fluorine content, lithium metal (Li) cycling at over 99% Coulombic efficiency (CE) for over 200 cycles at 3 mA cm⁻² and 3 mAh cm⁻² is demonstrated in addition to stable cycling of Li/NMC622 full batteries from −60 to +55° C. Additionally, the invention demonstrates that the vapor pressure-temperature relationship unique to LGE systems allows for a one-step solvent recycling process, which promises sustainable operation at scale.

The disclosed technology can be implemented in some embodiments to provide the process of recycling spent liquid-based electrolytes in batteries. This method recollects liquefied gas solvent molecules for immediate reuse in new batteries.

The disclosed technology can be implemented in some embodiments to provide a simple and practical process to efficiently recycle used electrolyte solvent. To date, there is no practical method that readily recycles the liquid-based electrolyte solvent in batteries.

Industries are increasing efforts on the investigation of battery recycle processes. Most battery recycling efforts are focused on electrode materials recycling, with little progress on electrolyte recycling. The only reported approach is using supercritical CO₂ extraction for organic electrolytes in lithium-ion batteries. However, this process requires high pressure (up to 35 MPa), high temperature (up to 50° C.), and long extraction time (up to 75 min), which makes it expensive andimpractical. To date, there is no existing method that efficiently recycles liquid-based electrolyte due to the high viscosity and volatility of electrolyte solvents. The proposed recycling process using liquefied gas solvent molecules is capable of a higher recovery yield through a simplified method.

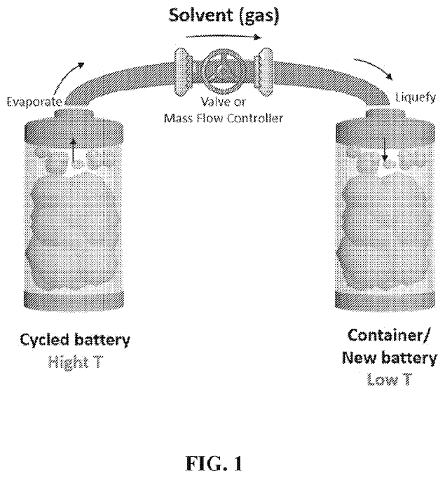

FIG. 1 is a schematic illustration of an electrolyte solvent recycle process based on some implementations of the disclosed technology.

In some implementations of the disclosed technology, an electrolyte solvent recycle process is based on the use of liquefied gas solvents, which exist in the gaseous state under ambient pressure. The gas molecules can be liquefied under moderate pressure to form liquefied gas electrolytes. The vapor pressure of the liquefied solvents rises accordingly as the temperature of the system increases. Referring to FIG. 1, using this vapor pressure-temperature relationship for liquefied gas solvents, a practical solvent recycle process is proposed.

A cycled battery with spent liquefied gas electrolyte is connected to an empty container or a new battery without electrolyte solvent. To create a pressure difference, the cycled battery and new battery are placed in a high and low-temperature environment, respectively. The solvent is transferred by opening and controlling a valve or mass flow controller connected to the batteries. When the valve to the cycled battery is opened, the liquefied gas solvent molecules evaporate. The evaporated solvent molecules subsequently transfer and liquefy in the low-temperature container/new battery. This solvent transfer is driven by the pressure difference generated by different temperatures. The proposed method could potentially be a simple approach to collect and reuse the electrolyte solvent for battery applications.

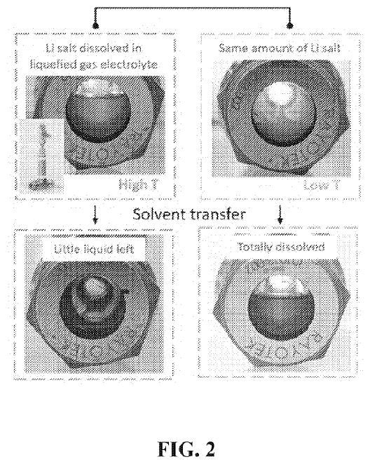

FIG. 2 shows observation of liquefied gas solvents recycling from window cell.

Referring to FIG. 2, tests can be performed using window cells to directly observe the solvent transport. A window cell with liquefied gas electrolyte is placed in a temperature chamber set to a higher temperature (+20 to +40° C., Pvapor=>80 psi). The window cell contained Li salt and liquefied gas solvent to simulate a battery's electrolyte. This window cell with liquefied gas electrolyte is connected to a second window cell, which contained the same amount of Li salt and is in a low-temperature environment (0 to −40° C., Pvapor=<20 psi). Once the two window cells are connected, the valve is opened to cause solvent transfer. The large pressure difference drives the mass transfer for the recycling process. After solvent transfer is complete, the Li salt in the low-temperature window cell became fully dissolved, illustrating the success of this recycling method. A successful prototype for this process has been demonstrated, as most of the solvent molecules in the high-temperature window cell is transferred and liquefied in the low-temperature temperature window cell. The resulting well-mixed, new liquefied gas electrolyte proves the capability to recycle liquefied gas electrolytes.

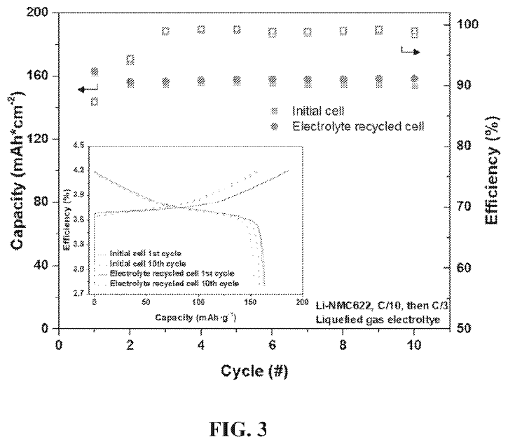

FIG. 3 shows demonstration of recycling liquefied gas solvents in batteries.

For further proof-of-concept, lithium metal batteries (Li—LiNi0.6Mn0.2Co0.2O2 (NMC622)) are assembled and used to test the effectiveness of the proposed one step solvent recycling process. A Li-NMC coin cell is first built in a custom high-pressure coin cell using liquefied gas electrolyte. A second Li-NMC coin cell is also assembled, which only contained Li salt for the electrolyte. The initial cell containing the liquefied gas electrolyte is tested for 10 complete cycles. Using the same recycling process outlined previously, the liquefied gas solvent molecules are transferred to the Li-NMC coin cell that only contained Li salt. Subsequently, the new battery is tested with the recycled electrolyte solvent, with no additional solvent. Notably, the performance for electrolyte recycled cell shows nearly identical capacity, efficiency, and voltage curve in comparison to the original cell (FIG. 3). These results demonstrate the effectiveness of this simple solvent recycling process.

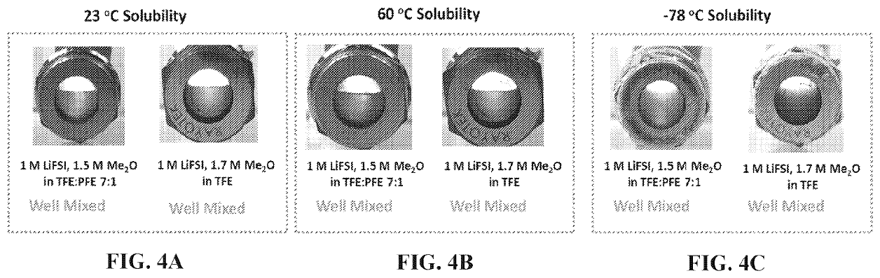

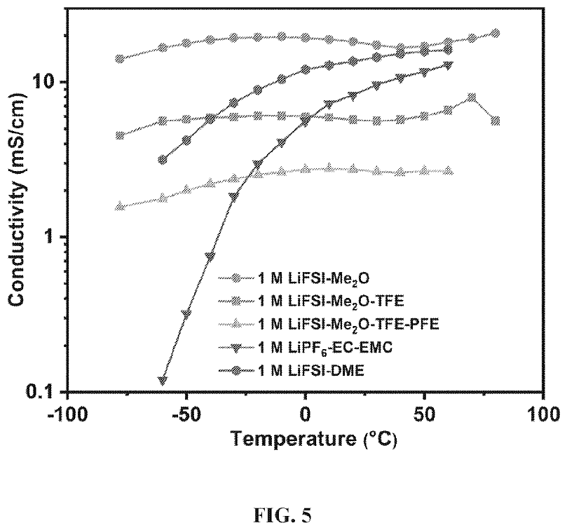

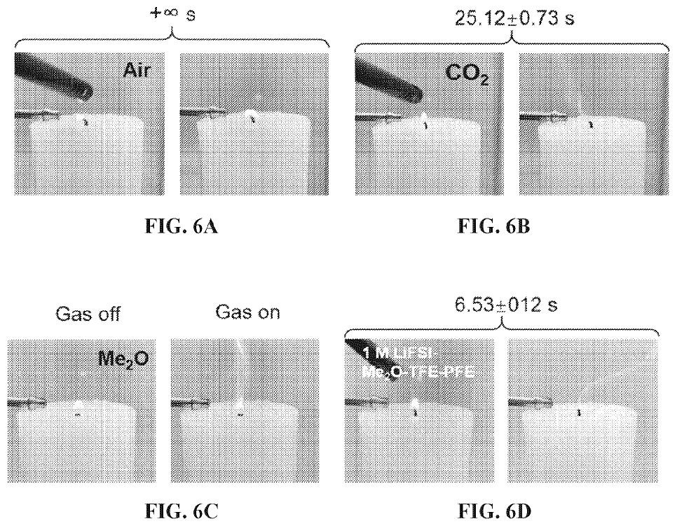

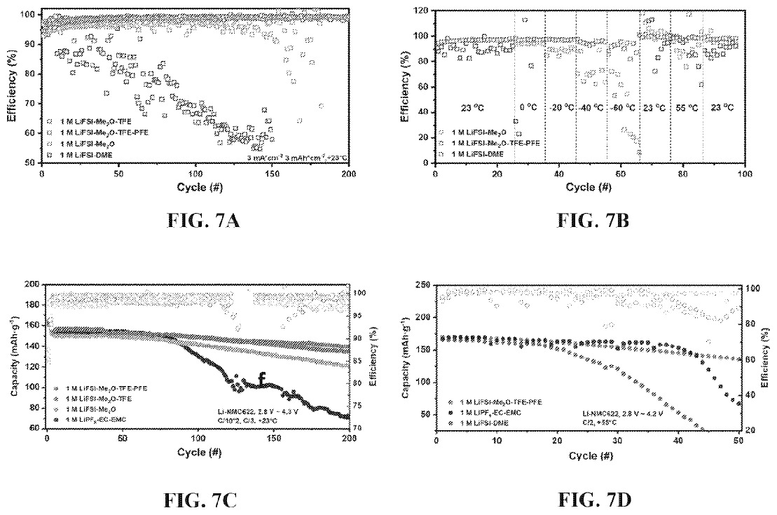

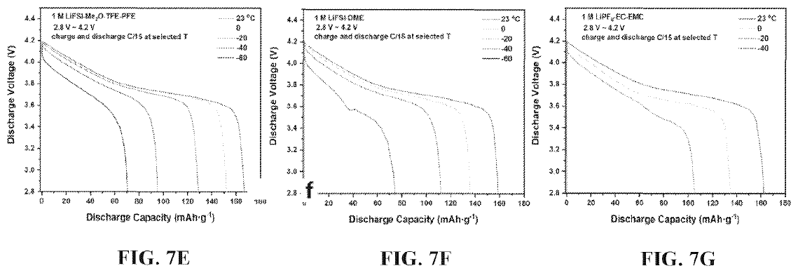

FIGS. 4A-4C show salt solubility tests of studied electrolytes at selected different temperatures. FIG. 5 shows ionic conductivities of studied electrolytes from −78 to 80° C. FIGS. 6A-6D show optical images of extinguishing ignited candle tests of different gases: FIG. 6A: Air; FIG. 6B: Carbon dioxide; FIG. 6C: Me₂O; FIG. 6D: 1 M LiFSI-Me₂O-TFE-PFE. Except Me₂O, all of gases are applied 150 standard cubic centimeters per minute (sccm) flow rate to extinguish the ignited candles. FIGS. 7A-7D show electrochemical performance of lithium metal anode and Li-NMC622 cells in liquefied gas electrolytes. FIG. 7A shows the CE of Li metal plating/stripping over 200 cycles in various electrolytes at +20° C. FIG. 7B shows CE of Li metal plating/stripping over 200 cycles in various electrolytes at different temperatures. FIG. 7C shows Li-NMC622 long-term cycling at +23° C. FIG. 7D shows Li-NMC622 long-term cycling at 55° C. FIGS. 7E-7G show Li-NMC622 charge and discharge at selected temperature for (FIG. 7E) LGE, (FIG. 7F) ether and (FIG. 7G) carbonated electrolytes.

The disclosed technology can be implemented in some embodiments to use fire-extinguishing liquefied gas electrolytes in batteries. This method is able to overcome the flammability issues existing in the current state-of-the-art electrolyte systems while maintaining stable long-term cycling and wide temperature operation from-80 to +60° C.

In recent decades, the demand for batteries has increased exponentially and applications have expanded from small-scale portable electronics to large-scale areas such as EV and grid storage. Current state-of-the-art electrolyte systems are represented by carbonate-based electrolytes in commercial batteries, which are highly flammable and are limited by a narrow temperature window (−20 to +50° C.). As a result, commercial electrolytes pose major safety concerns and are insufficient for wide-temperature operations. The novel fire-extinguishing electrolyte system implemented based on some embodiments of the disclosed technology addresses major safety concerns in traditional electrolytes and may avoid the thermal runaway and propagation at the beginning state while offering impressive performance. Notably, the fire-extinguishing electrolyte implemented based on some embodiments of the disclosed technology has fast transport from −80 to +80° C., excellent lithium metal plating and stripping at aggressive current densities, and stable long-term cycling for 4 V cathodes both at room temperature and −20° C. The existing technologies to solve the safety issues mainly uses non-flammable phosphate-based solvents mixed with flammable dilutes to formulate a localized highly concentrated electrolyte, however, it suffers from relatively poor compatibility of lithium metal, relatively low boiling point, or the flammability of dilutes.

The electrolyte system implemented based on some embodiments of the disclosed technology can use dimethyl ether (Me₂O) as the main solvent to dissolve Lithium bis(fluorosulfonyl)imide (LiFSI) salt. Since Me₂O is the simplest ether, it is expected to have relatively good solvation ability, reductive stability, and rapid transport. Me₂O exists in the gaseous state at ambient temperatures and pressures, with the higher critical point up to 120° C. and moderate vapor pressure (Table 1). Furthermore, several fire-extinguishing liquefied gas solvents with lower solvation power are introduced as co-solvents to improve the safety feature and to formulate a localized highly concentrated electrolyte system. The 1,1,1,2-tetrafluoroethane (TFE) and pentafluoroethane (PFE) are the two main candidates and their fire-extinguishing features are proved by candle tests (FIGS. 6A-6D). In the system implemented based on some embodiments of the disclosed technology, 1 M LiFSI salt is dissolved in the TFE co-solvent with a salt-to-solvent (LiFSI:Me₂O) ratio of 1:1.7. In addition, 1 M LiFSI salt is miscible with a 7:1 volume ratio of TFE and PFE co-solvent mixtures with a salt-to-solvent (LIFSI:Me₂O) ratio of 1:1.5. The solubility tests are also performed under different temperatures and displayed a fully miscible electrolyte in a wide temperature range. Both electrolytes showed more than 1 mS/cm ionic conductivities from −78 to +60° C. They also enable excellent lithium metal stability at aggressive current densities (3 mA/cm²) and relatively stable Li—LiNi0.6Mn0.2Co0.2O2 (NMC622) cycling both at room temperature and at different subzero temperatures.

TABLE 1
Physical properties of Me2O, TFE and PFE

| | Melting | Boiling | Critical | | Vapor | | | |
|---|---|---|---|---|---|---|---|---|
| | Point | Point | Point | Flash | Pressure | | Dielectric | Viscosity |
| Solvent | (° C.) | (° C.) | (° C.) | Point | (psi) | Dipole | Constant | (mPa · s) |
| DimethylEther | −141 | −24 | 127 | −41 | 75 | 1.3 | 5.02 | 0.12 |
| 1,1,1,2- | −103 | −26.3 | 101 | 250 | 82 | 2.06 | 9.7 | 0.207 |
| Tetrafluoroethane | | | | | | | | |
| Penta fluoroethane | −103 | −48.5 | 66 | None | 175 | 1.56 | 4.5 | 0.15 |
| Fluoromethane | −144 | −78 | 44 | — | 494 | 1.85 | 9.7 | 0.085 |

Table 1 shows the physical properties of Me₂O, TFE and PFE. Me₂O has a low melting point (down to −141° C.) and a high critical point (up to +127° C.), with a moderate pressure of 75 psi at room temperature. TFE and PFE are non-flammable with low melting points and low vapor pressures. FIGS. 4A-4C show the salt solubility of the studied electrolytes at various temperatures. There are no observations of salt precipitations or phase separations for both electrolytes at the selected temperatures. FIG. 5 shows the ionic conductivities of the studied electrolytes and presents a comparison to dilute 1 MLiFSI in Me₂O electrolytes. FIGS. 6A-6D demonstrate that the fire-extinguishing feature of the electrolytes implemented based on some embodiments of the disclosed technology. This test is performed using a candle test, which is an established protocol for flammability testing. All tests are performed in a controlled setting using constant variables. The flammability of the proposed non-flammable liquefied gas electrolyte is compared to several controls, which are air, CO₂ and Me₂O. As seen in FIG. 6, the flow of air cannot extinguish the fire, whereas CO₂ can extinguish the fire within 25 seconds. Although our studied electrolyte contains flammable Me₂O gas, it still suppresses fire in only 6.5 seconds. This straightforward candle test successfully illustrates the fire-extinguishing feature of our novel liquefied gas electrolyte. By addressing the major safety concern of traditional electrolytes, our new electrolyte can serve as a safe energy storage system. FIGS. 7A-7G show stable lithium metal cycling performance at an aggressive rate of 3 mA/cm² to a practical capacity of 3 mAh/cm². The studied electrolyte enables more than 91.5% capacity retention of Li/NMC622 cycling after 200 cycles. It also maintains excellent low and high-temperature performance in comparison to traditional carbonated-and ether-based solvents.

The disclosed technology can be implemented in some embodiments to provide a new design direction to produce a fire-extinguishing electrolyte for lithium metal anode, which will significantly improve the safety features of lithium-ion batteries without sacrifice the performance.

The combination of high energy density, improved safety, environmental sustainability and wide temperature operation range is the ultimate goal when designing next-generation electrolytes for lithium-based secondary batteries. However, due to the inherently divergent nature of many of these metrics, the majority of electrolytes fail to satisfy the above requirements simultaneously. Based on the compositions of clean fire extinguishing agents, the disclosed technology can be implemented in some embodiments to provide inherently safe liquefied gas electrolytes (LGE) based on 1,1,1,2-tetrafluoroethane (TFE) and pentafluoroethane (PFE) that maintain more than 3 mS cm⁻¹ ionic conductivity from −78 to +80° C. Benefiting from a solvation structure which limits parasitic reactivity, and a high bulk fluorine content, lithium metal (Li) cycling at >99% Coulombic efficiency (CE) for over 200 cycles at 3 mA cm⁻² and 3mAh cm⁻² was demonstrated in addition to stable cycling of Li/NMC622 full batteries from −60 to +55° C. The disclosed technology can be implemented in some embodiments to use the vapor pressure-temperature relationship unique to LGE systems allows for a one-step solvent recycling process, which promises sustainable operation at scale. The disclosed technology can be implemented in some embodiments to provide a route to sustainable, temperature resilient lithium metal batteries with unique fire-extinguishing properties that maintain state-of-the-art electrochemical performance.

In recent decades, the demand for high-energy secondary batteries has increased exponentially, with their applications expanding from portable electronics to electric vehicles and grid storage. The Li metal anode is considered as the most promising candidates for high energy density rechargeable battery due to its highest theoretical specific capacity (3,860 mAh·g⁻¹) and lowest electrochemical potential (−3.04 V versus the standard hydrogen electrode). However, safety concerns associated with dendrite growth along with the limited cycle life and capacity decay at subzero temperature hampers their practical application. As the above issues are highly contingent on the physical and chemical properties of the battery electrolyte, the development of novel chemistries and design strategies are crucial to solving them.

To this end, a relatively limited number of battery electrolytes have demonstrated highly reversible lithium metal performance capable of producing hundreds of cycles at the full-cell level. The progress is limited due to parasitic reactions of Li metal with electrolytes from solid electrolyte interphase (SEI) cracking, porous plating morphologies, and dendrite formation, leading to irreversibility of Li cycling. Furthermore, atypical cycling temperatures introduce additional design complexity, where low-temperatures have been demonstrated to result in dendritic morphologies and poor reversibility, and increased temperatures tend to exacerbate parasitic reactivity of all kinds. Even if these metrics were to be obtained in a single system, the inherent flammability of common solvents with desirable reductive stability (e.g., ethers) is sub-optimal. Although non-flammable solvents exist, their long-term electrochemical stability is often problematic, mainly caused by their instability with the Li metal anode. To further complicate these already stringent design considerations, the widespread production of Li metal batteries is also highly dependent on the economic and environmental sustainability of the cells, where the recyclability of every component including the electrolyte is highly desirable. Given all of these factors, the design of electrolyte systems that consist of temperature resilient reversibility, inherently safe physical properties, and a viable route to environmentally and economically sustainable application is a seemingly insurmountable challenge.

Extensive efforts have been devoted to developing non-flammable electrolytes, but all of them fail to satisfy aforementioned requirements simultaneously. Solid-state electrolytes are regarded as promising candidates owing to their non-flammable nature and high packing density that can potentially boost the energy density of batteries. However, the ionic conductivity of solid-state electrolytes suffers even at moderately low temperatures (<0° C.), which casts doubts on their practical use where a wide temperature window is needed. Ionic liquid electrolytes with molten salts present low volatility and low, or non-flammability, however their high viscosity (particularly at low temperatures) and cost limit their applications. Besides that, little to no reports of solid-state electrolytes or ionic liquids have demonstrated viable Li metal performance in full cells without the introduction of additional cell components. In commonly used liquid electrolytes, organic non-flammable phosphates solvents such as trimethyl phosphate (TMP) and triethyl phosphate (TEP) have been explored to obtain enhanced safety. Although such solvents are unable to produce stable solid electrolyte interphases (SEI) on either graphite or Li metal anodes, increasing the salt concentration of TMP-based electrolytes has been shown to promote salt-derived inorganic SEI layers and consequently improve the interface stability as well as maintain safe operation. Yet cost, viscosity, electrode wetting, and low-temperature performance are sacrificed in these high-concentration systems. More recently, localized high-concentration electrolytes (LHCE) were formulated by adding inert dilutes to lower the viscosity of the whole electrolyte, improving upon the above-mentioned issues while maintaining all the desired properties for battery performance. Based on this concept, non-flammable LHCEs were developed by coupling inert dilutes like bis(2,2,2-trifluoroethyl)ether (BTFE) with non-flammable solvents such as TMP or TEP. Fire-retardant LHCEs were also formulated by using non-flammable dilutes, for example 2,2,2-trifluoroethyl 1,1,2,2-tetrafluoroethyl ether (HFE) with flammable solvents. Although these LHCE delivered a higher CE for Li metal and better capacity retention over long-term cycling, the diluents are often flammable or decrease conductivity of the electrolyte, with relatively low boiling points (BTFE, +62° C.; HFE, +57° C.) hindering their operation at higher temperature. Though the vast array of previously explored chemistries has made significant progress either improving electrochemical performance, safety or renewability metrics, an electrolyte chemistry which comprehensively addresses all of them has yet to be demonstrated.

To circumvent the conventional liquid phase temperature window, a transformative concept of using a variety of hydrofluorocarbon liquefied gas as the main solvents can be used. Owing to ultra-low viscosity, these LGEs display improved performance at low temperature. To expand on the original LGE systems, another advancement in performance was also made through the addition of other co-solvents such as tetrahydrofuran and acetonitrile respectively, which resulted in stable Li plating and stripping over 500 cycles with an average CE of 99.6% and Li/NMC cycling with more than 96.5% capacity retention after 500 cycles. However, the utilization of high pressure and flammable gasses may not satisfy the previously discussed safety and environment concerns.

The disclosed technology can be implemented in some embodiments to provide a versatile liquefied gas electrolyte for wide-temperature lithium metal batteries with intrinsic fire-extinguishing properties and economical recollection after utilization. By rationally designing TFE, PFE-based electrolytes, the disclosed technology can be implemented in some embodiments to provide self-fire-extinguishing devices and methods and a simple one-step solvent recycling process. Due to sufficiently high ionic conductivity over wide temperature range, favorable solvation structure, and SEI formation, the designed LGEs showed stable Li metal cycling with a CE of 99% and long-term Li/NMC622 cycling up to 4.2 V from −60° C. to +55° C.

### Rational Design of Liquefied Gas Electrolytes

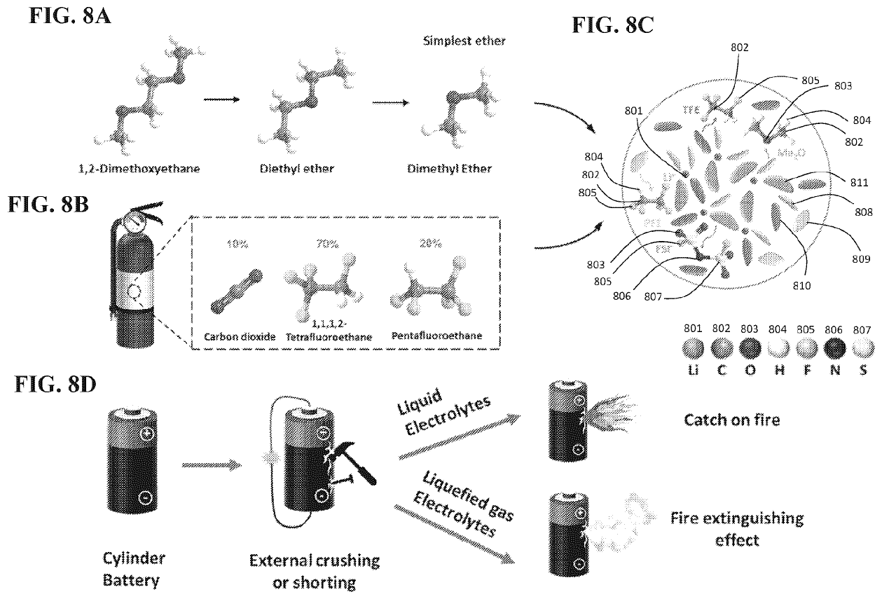

FIGS. 8A-8D show examples of liquefied gas electrolytes. FIG. 8A shows selected dimethyl ether, as the simplest ether, is expected to transfer properties from other ethers, including solvation ability and transport features. FIG. 8B shows composition with clean extinguishing agent FS 49 C2. FIG. 8C shows an example solvation structure of liquefied gas electrolytes implemented based on some embodiments of the disclosed technology (Li⁺: 801, C: 802, O: 803, H: 804, F: 805, N: 806, S: 807, Me₂O: 808, PFE: 809, TFE: 810, FSI⁻: 811). FIG. 8D shows schematic of fire extinguishing and cooling down mechanism for liquefied gas electrolyte.

TABLE 2
Physical properties of the different solvents. Vapor pressure, dipole, relative
dielectric, and viscosity values taken as a saturated liquid at +20° C.

| | Melting | Boiling | Critical | Flash | Vapor | | | |
|---|---|---|---|---|---|---|---|---|
| | Point | Point | Point | Point | Pressure | Dipole | Dielectric | Viscosity |
| Solvent | (° C.) | (° C.) | (° C.) | (° C.) | (psi) | (Debye) | Constant | (mPa · s) |
| 1,2- | −58 | 85 | 263 | −2 | 0.93 | 1.71 | 7.2 | 0.46 |
| Dimethoxyethane | | | | | | | | |
| Diethyl Ether | −117 | 35 | 194 | 35 | 10.28 | 1.3 | 4.33 | 0.224 |
| DimethylEther | −141 | −24 | 127 | −41 | 75 | 1.3 | 5.02 | 0.12 |
| 1,1,1,2- | −103 | −26.3 | 101 | 250 | 82 | 2.06 | 9.7 | 0.207 |
| Tetrafluoroethane | | | | | | | | |
| Penta fluoroethane | −103 | −48.5 | 66 | None | 175 | 1.56 | 4.5 | 0.15 |
| 1,1,1,2,3,3,3 - | −131 | −15.6 | 102 | None | 65.7 | 1.46 | 2.0 | 0.244 |
| Heptafluoropropane | | | | | | | | |
| Fluoromethane | −144 | −78 | 44 | — | 494 | 1.85 | 9.7 | 0.085 |

The desired liquefied gas solvents need to satisfy a number of criteria: (1) sufficient solvation ability to achieve, larger than 1M salt solubility; (2) sufficiently low vapor pressure, preferably lower than fluoromethane (FM); (3) low-or non-flammability; (4) low viscosity and (5) low freezing point. As no single solvent satisfies all criteria, a mixture of non-flammable, low viscosity, low vapor pressure hydrofluorocarbons and Lit coordinating ethers can be utilized to achieve a balanced electrolyte. Compared with different ethers' properties (FIG. 8A), dimethyl ether (Me₂O) exists in the gaseous state at ambient conditions. Of the ethers, it has the lowest freezing point and viscosity combined with high solvating power, reductive stability and good compatibility with Li metal. By comparison with the previously reported FM solvent, Me₂O has higher critical point at 127° C. and lower vapor pressure-down to 75 psi at room temperature (Table 2). Despite its flammability, Me₂O generates non-toxic and noncorrosive (e.g., H₂O) products after combustion, whereas the combustion of flammable fluorinated solvents such as fluoromethane and the widely used BTFE results in the generation of hydrogen fluoride.

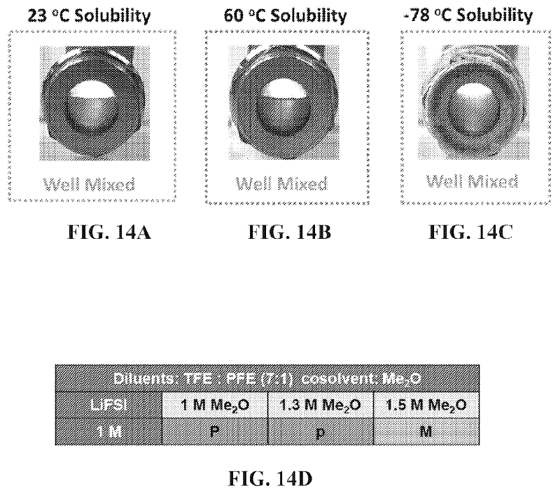

To tackle the flammability issues, a non-flammable solvent needs to be a majority component in a mixture. The ideal non-flammable cosolvent would have low or moderate vapor pressure, low viscosity, wide temperature range, broad electrochemical window, and low solvation ability to maintain desirable physicochemical properties and cell performance. Based on these principles and inspired by the fire-extinguishing agents FS 49 C2 (FIG. 8B, FIG. 14), the disclosed technology can be implemented in some embodiments to use TFE and PFE as potential liquefied gas cosolvents. With a high flash point (TFE, T_{flash}=+250° C.), non-flammability of PFE and high fluorine atom ratios, these molecules also exhibit moderate vapor pressure, low melting point (down to −103° C.), and low HUMO (Highest Occupied Molecular Orbital) energy (Table 2). The proposed electrolyte system is shown in FIG. 8C after combining Me₂O with TFE/PFE and salt. Due to the strong bonding energy and low polarity of the C—F bond, TFE and PFE are expected to have low solvation ability with lithium salts and largely serve as inert agents. All Me₂O solvents are coordinating Li⁺ and its aggregates resulting in the enhanced oxidative stability of Me₂O due to absence of uncoordinated Me₂O. Owing to the fire-extinguishing characteristics of TFE and PFE, the battery operation under harsh situations would significantly suppress flames (FIG. 8D). By comparison, batteries using conventional flammable carbonated solvents would result in severe thermal runaway and easily cause fires. Furthermore, the moderate vapor pressure would also enable a simple separation and recycle process to collect used solvents, which is discussed below.

As for the salt selection, lithium bis(fluorosulfonyl)imide (LiFSI) and lithium bis(trifluoromethanesulfonyl)imide (LiTFSI) are considered as appropriate salt candidates due to their lower dissociation energy over lithium hexafluorophosphate (LiPF₆) and lithium tetrafluoroborate (LiBF₄) and the formation of high fluorine content interfaces. After performing the solubility tests on LiFSI/LiTFSI-Me₂O-TFE/PFE mixture (FIGS. 16, 17A-17D), 1 MLiFSI, 1.7 M Me₂O in TFE (labeled as 1 M LiFSI-Me₂O-TFE) and 1 M LiFSI, 1.5 M Me₂O in TFE: PFE 7:1 volume ratio (labeled as 1 M LiFSI-Me₂O-TFE-PFE) are selected by way of example.

### Transport and Safety Properties

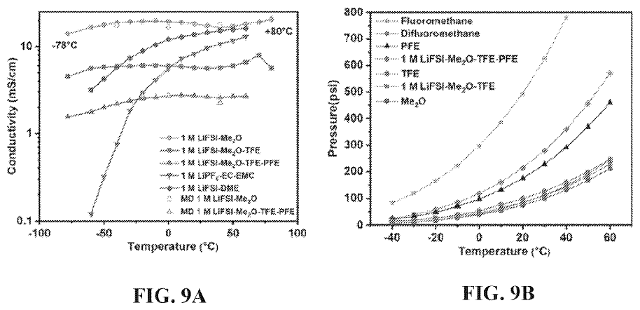

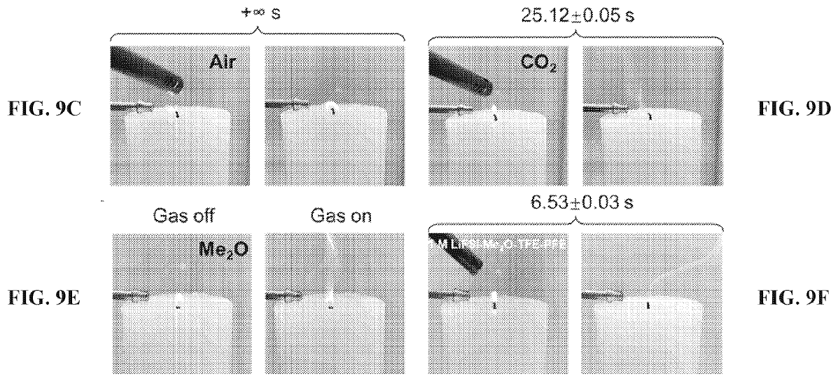

FIGS. 9A-9F show properties of liquefied gas electrolytes. FIG. 9A shows ionic conductivity of the liquefied gas electrolytes over a wide temperature range. FIG. 9B shows vapor pressure of various liquefied gas solvents and electrolytes. FIGS. 9C-9F shows fire douse tests of different pure gases or gas mixtures (FIG. 9C) air (FIG. 9D) CO₂ (FIG. 9E) Me₂O and (FIG. 9F) 1 M LiFSI-Me₂O-TFE-PFE demonstrated by ignited candles.

The electrolytic conductivities of the liquefied gas electrolytes were measured and shown in FIG. 9A. In contrast with a sharp conductivity drop observed for traditional electrolytes such as 1 M LiPF₆ in ethylene carbonate/ethyl methyl carbonate with a 3:7 weight ratio (labeled as 1 M LiPF₆ in EC-EMC) or 1 M LiFSI in 1,2-dimethoxyethane (labeled as 1 M LiFSI-DME), liquefied gas electrolytes 1 M LiFSI-Me₂O, 1 M LiFSI-Me₂O-TFE, and 1 M LiFSI-Me₂O-TFE-PFE exhibit near constant conductivity >1 mS/cm over a wide temperature range (−78 to +80° C.). The enhanced ionic conductivity at low temperature for the liquefied gas electrolytes is attributed to the low viscosity and low melting point. Notably, conductivities measured in the 1 M LiFSI-Me₂O and 1 M LiFSI-Me₂O-TFE electrolytes exceed 14.1 mS/cm and 4.5 mS/cm respectively, in the temperature range of −78° C. to +70° C. The conductivity of as-obtained electrolytes at low temperature compares favorably to most other electrolyte systems, which experience severe conductivity drop at low temperature. The changes in vapor pressure over a range of temperature for different liquefied gas solvents and electrolytes are shown in FIG. 9B. In contrast to the previously proposed FM-based liquefied gas electrolytes, the Me₂O, TFE, and PFE-based electrolyte and its components have significantly lower vapor pressure. Specifically, vapor pressure of Me₂O, TFE and PFE is only 15%, 17%, and 35% of FM's vapor pressure at +20° C., respectively. Me₂O and TFE have similar vapor pressures over a wide temperature range with high critical points. In some implementations, a TFE:PFE volume ratio of 7:1 can be utilized to closely follow the composition of the fire-extinguisher FS 49 C2. This mixture has a lower operation pressure than pure PFE solvent. The resulting 1 M LiFSI-Me₂O-TFE-PFE electrolyte possesses both improved safety and wide temperature operation window.

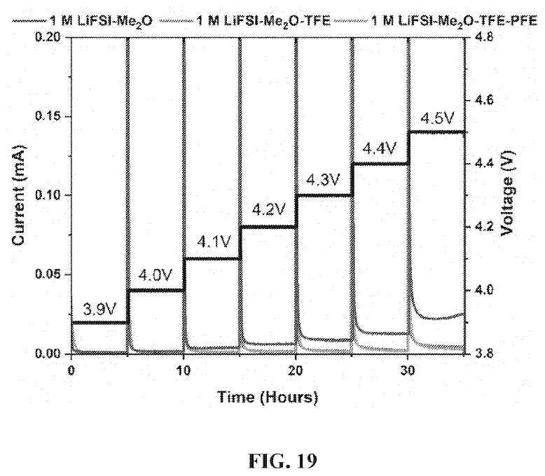

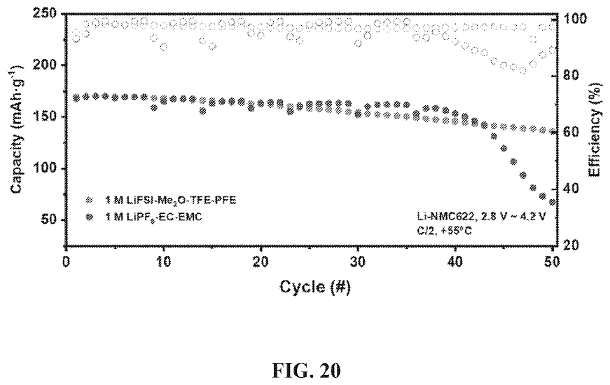

In some implementations, the fire extinguishing effectiveness of the 1 MLiFSI-Me₂O-TFE-PFE electrolyte can be validated by fire douse test (FIG. 19). Tests may be conducted by blowing an ignited candle with various types of gases and gas mixtures at a constant gas flow rate. Air gas is used as a reference to demonstrate the flow rate set in the tests does not influence the fire flame (FIG. 9C). CO₂ gas shows a suppression of fire after a relatively long time of around 25 seconds, by gradually decreasing the local oxygen concentration (FIG. 9D). Meanwhile, due to the strong chemical C—F bond and faster heat adsorption, the individual TFE and PFE components effectively extinguish fire within 1.4 seconds. This occurs as the agent changes from liquid to gas phase during venting in addition to the presence of C—F bonds that block the chain reactions (FIGS. 20a-20b). As expected, Me₂O gas demonstrates high flammability that leads to a stronger flame (FIG. 9E). To verify the fire-extinguishing features of the proposed 1 MLiFSI-Me₂O-TFE-PFE electrolyte, gas solvents are directly released to the ignited fire flame. We observed robust fire suppression in a much shorter time than observed for pure CO₂ (FIG. 9F) despite the small content of Me₂O present in the electrolyte (FIG. 9E). Based on above results, we conclude that the 1 M LiFSI-Me₂O-TFE-PFE electrolyte is self-flame-extinguishing.

### Electrochemical Performance

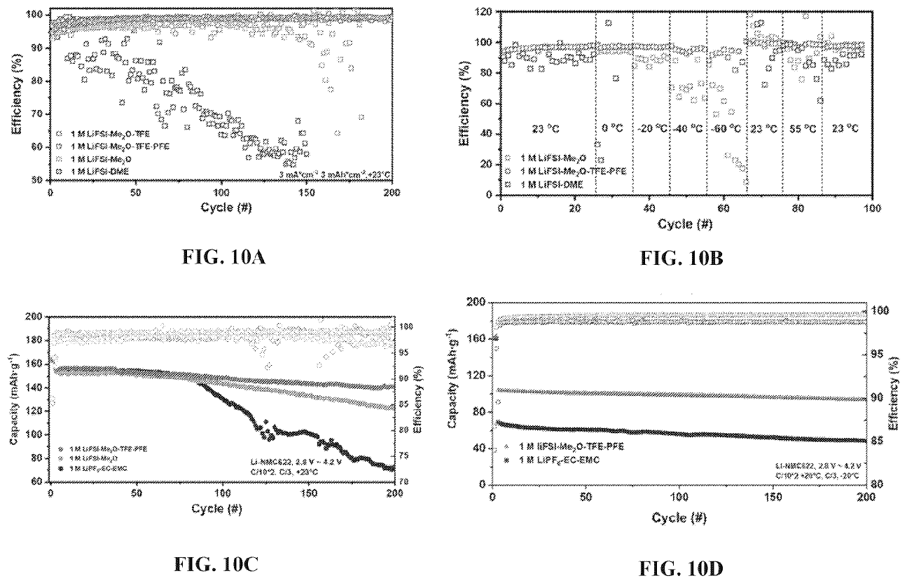

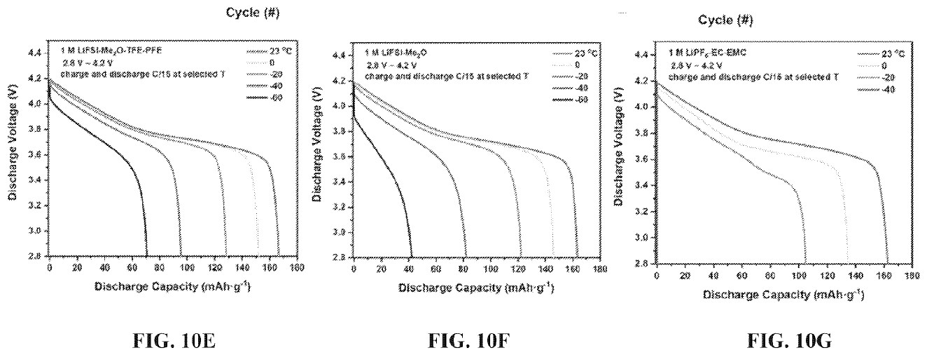

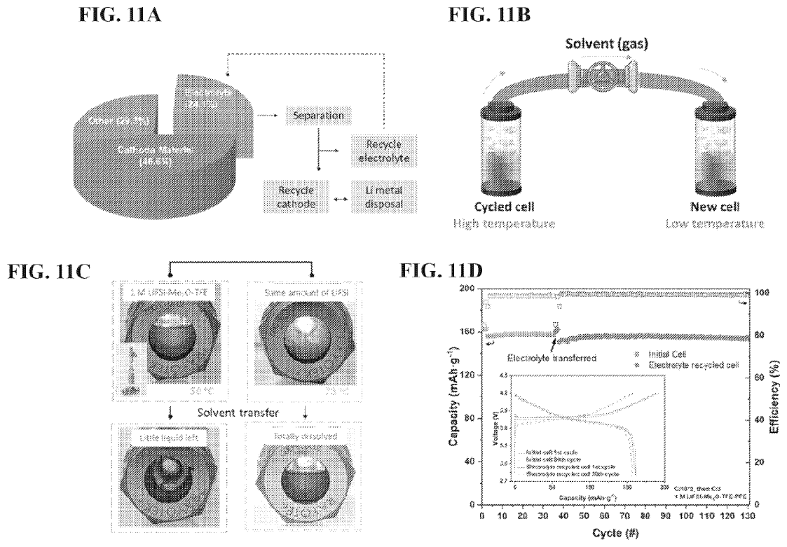

FIGS. 10A-10G show electrochemical performance of lithium metal anode and Li-NMC622 cells in liquefied gas electrolytes. FIG. 10A shows the CE of Li metal plating/stripping over 200 cycles in various electrolytes at +20° C. FIG. 10B shows the CE of Li metal plating/stripping over 200 cycles in various electrolytes at different temperatures. FIG. 10C shows Li-NMC622 long-term cycling at +23° C. FIG. 10D shows Li-NMC622 long-term cycling at —20° C. Li-NMC622 charge and discharge at selected temperature for (FIG. 10E) LGE, (FIG. 10F) ether and (FIG. 10G) carbonated electrolytes. The NMC622 loading is 1.8 mg/cm².

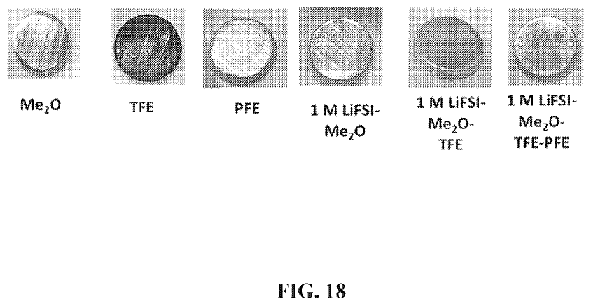

Li metal soak tests were first performed to examine the compatibility of electrolytes with Li metal (FIG. 18). It was observed that the Li metal retained a clean and polished appearance after soaking in the 1 MLiFSI-Me₂O, 1 M LiFSI-Me₂O-TFE and 1 M LiFSI-Me₂O-TFE-PFE electrolytes for 15 days. For Li metal plating/stripping tests, the ether-based liquid electrolyte could cycle well under mild conditions (0.5 mA cm⁻², 1 mAh cm⁻²). However, under a current density of 3 mA cm⁻² with a practical capacity of 3 mAh cm⁻², the performance of Li metal anode in 1 M LiFSI-DME quickly drops after 9 cycles (FIG. 10A). The cell using 1 MLiFSI-Me₂O could cycle with a 96.4% average CE in the first 100 cycles, suggesting an improved Li metal compatibility of Me₂O over DME, although CE fades in following cycles. On the contrary, the liquefied gas electrolytes using 1 MLiFSI-Me₂O-TFE-PFE and 1 M LiFSI-Me₂O-TFE deliver a first cycle CEs of 94.8% and 96.4%, respectively. Average CEs of 98.8% and 99.0% are achieved in the subsequent 200 cycles (FIG. 10A), demonstrating their electrochemical compatibility with Li metal anodes and indicating the robustness of the salt-derived SEI. The 1 M LiFSI-Me₂O-TFE-PFE is further investigated in a wide temperature range, where it retains average CEs of 97.4%, 97.2%, 95.2% and 91% at 0, −20, −40 and −60° C. respectively, under the same current density of 3 mA cm⁻² and plating capacity of 3 mAh cm⁻². In comparison, the low concentration counterpart delivers an average CE of 73.7% at −40° C. and the cell malfunctions at −60° C. with severe CE fluctuation. Although the reference 1 M LiFSI-DME liquid electrolyte uses a mild 1 mA cm⁻² and 1 mAh cm⁻² condition, the cell fades dramatically at subzero temperature due to the solvent-dominated solvation structure and low transference number (FIG. 10B).

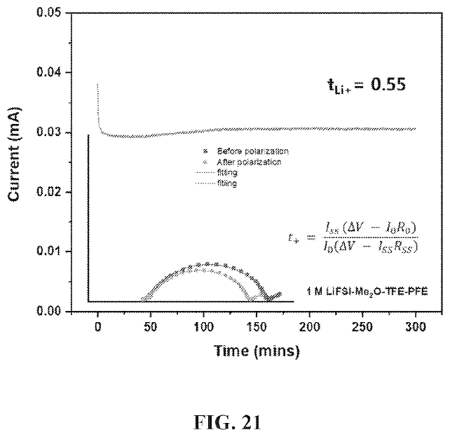

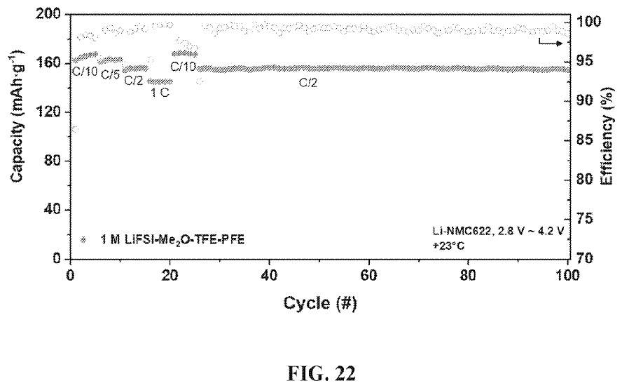

Cells including a Li metal anode and a LiNi0.6Mn0.2 Co0.2O2 cathode (NMC622) with an average loading of ˜1.8 mAh cm⁻² were fabricated to investigate the oxidative stability of the liquefied gas electrolyte. As a comparison, a widely used commercial electrolyte consisting of 1 M LiPF₆ in ethylene carbonate/ethyl methyl carbonate with a 3:7 weight ratio (Gen2) was selected for the reference cell. Based on a Li-NMC622 voltage hold test (FIG. 19), 1 M LiFSI-Me₂O-TFE and 1 M LiFSI-Me₂O-TFE-PFE electrolytes exhibit oxidation stability up to 4.4 V. At room temperature and 4.2 V upper voltage, the Li-NMC622 cells in 1 M Me₂O-TFE-PFE provides average CE of 99.2% with capacity retention of 90.6% over 200 cycles (FIG. 10C). In comparison, the carbonate-based electrolyte shows a quicker capacity fade. Similarly, at reduced temperature (−20° C.) the 1 M LiFSI-Me₂O-TFE-PFE electrolyte exhibits a high average CE of 99.6% and a capacity retention of 90.5% after 200 cycles while carbonate-based electrolyte demonstrates lower average CEs and reduced (70.1%) capacity retention (FIG. 10D). Furthermore, the 1 MLiFSI-Me₂O-TFE-PFE electrolyte exhibits improved long-term cycling at +55° C. with a capacity retention of 80% after 50 cycles compared with Gen2 (FIG. 20). Owing to the high conductivity and high transference number of 0.59 (FIG. 21), it also shows an outstanding rate capability, with a 90% capacity retention under a C-rate of 1C and a 99.5% capacity retention under a C rate of C/2 after 100 cycles (FIG. 22).

To further evaluate the 1 M LiFSI-Me₂O-TFE-PFE electrolyte performance across a wide temperature window, the Li-NMC 622 cells were cycled with both carbonate and ether-based electrolytes as references. Under the same charge and discharge rate of C/15 and a cutoff voltage of 4.2 V, the discharge capacities are approximately the same across all three electrolytes at room temperature. At −60° C., the 1 MLiFSI-Me₂O and 1 M LiFSI-Me,O-TFE-PFE electrolytes demonstrate discharge capacities of 71 and 43 mAh g⁻¹ respectively (FIGS. 10E-10F). On the contrary, the carbonate-based electrolyte is incapable of charging and discharging at −40° C. (FIG. 10G). Based on the above results, we have successfully demonstrated the formulated LGE can maintain stable long-term cycling at room temperature and enhanced low temperature performance as well as steady rate capability, which paves the pathway to the next-generation lithium metal batteries with enhanced safety.

### Recyclability of Liquefied Gas Solvent

FIGS. 11A-11D show recycling concept and demonstration of liquefied gas electrolytes. FIG. 11A shows schematic of potential closed loop of liquid-based electrolytes direct recycling process. FIG. 11B shows schematic of practical process of liquefied gas solvent collection and recycle. FIG. 11C shows demonstration of the solvents transfer in window cell. FIG. 11D shows comparison of electrochemical performance of Li/NMC622 system between initial cell and cell using recycled solvents.

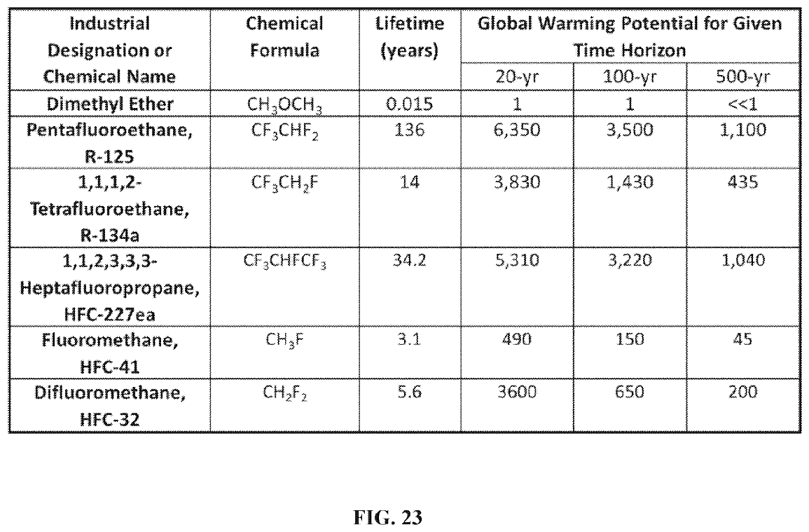

Battery recycling is crucial to reducing cost and removing the potential risks that battery components pose to the environment. To better understand the bottleneck of the battery recycling process, a closed loop of Li metal batteries recycling is illustrated in FIG. 11A. Even with a lean electrolyte condition, the electrolyte still takes a large ratio in weight (24%) in Li-NMC pouch cells. The electrolyte ratio would be even higher for more porous electrodes, such as sulfur. However, the electrolyte is not recovered but simply disposed during the electrolyte handling process. To efficiently collect the spent electrolytes, the primary challenge is to separate the electrolyte from electrodes considering the porous, high surface area of the electrodes and high viscosity of the electrolyte. Conventionally, supercritical CO₂ is employed for electrolyte extraction from both separators and electrode materials owing to its enhanced dissolution characteristics. In addition, the electrolyte salt and solvents can all be recovered when the extractant CO₂ is supplemented with some functional additives (e.g., ACN, PC). However, considering the intrinsic high-pressure nature of supercritical CO₂, the cost of this technique limits its wide application. By comparison, owing to the low viscosity, low boiling point of LGE systems, the case of evaporation controlled by temperature changes would not require a complicated separation process. Further, commercialization of LGE technology on large scales will require recycling of hydrofluorocarbon gases, otherwise the stable C—F bond from these F gases would cause a noticeable global warming effect (FIG. 23).

To overcome the above issues, a practical liquefied gas electrolyte solvent recycle process is proposed by using the vapor pressure-temperature relationship in liquefied gas solvents (FIG. 11B). If a temperature difference is generated between two connected containers with a liquefied solvent inside, the solvent will transfer and liquefy in the low-temperature container. This solvent transfer is driven by the pressure gradient generated by the temperature difference. The proposed method is a simple approach to collect and reuse the liquefied gas solvent. Tests using window cells were performed first as a control to directly observe the solvent transport (FIG. 11C). A window cell with 1 MLiFSI-Me₂O-TFE was placed in a temperature chamber with a higher temperature (+40° C., Pᵥₐₚₒᵣ=143 psi), which was connected to a second window cell with the same amount of LiFSI in a chamber with lower temperature (−40° C., Pᵥₐₚₒᵣ=13.9 psi). Driven by the large pressure difference, most of the solvents in the high-temperature cell were transferred and liquefied in the lower temperature end. This resulted in a well-mixed, new 1 MLiFSI-Me₂O-TFE-PFE electrolyte, proving the capability to recycle LGEs. Using the same process, the solvent of 1 M LiFSI-Me₂O-TFE-PFE in a cycled Li-NMC coin cell was successfully transferred into a newly assembled Li-NMC cell without adding any extra solvent. Notably, the performance for the recycled cell showed nearly identical capacity, efficiency, and a similar voltage profile in comparison to the original cell (FIG. 11D). These results demonstrate the effectiveness of this simple solvent recycle process. With further optimizations, this is a promising process for practical LGE recycling. The successful recycling of dimethyl-ether and hydrofluorocarbons co-solvents in the electrolyte solution not only creates new applications for the by-products synthesized from the conventional petroleum industry, but also endow them with sustainable energy.

The disclosed technology can be implemented in some embodiments to provide LGEs by adding the simplest (liquefied) ether to the non-flammable low solvating hydrofluorocarbon mixture. The resulting LGE is not only non-flammable but has a fire-extinguishing feature for suppression of flames. It delivers high performance over a wide temperature range (−78 to +80° C.) and enables a stable Li metal and Li/NMC cycling with high CEs. A practical electrolyte recycling process was demonstrated by using the unique features of liquefied gas solvents. The electrochemical, safety and recycling properties of the LGEs are derived directly from their physical and chemical properties. This study provides an insight into designing multi-functional electrolytes and presents an encouraging path towards the safer batteries with a wide operation temperature range and a feasible recycling process.

In some implementations, dimethyl ether (99%), 1,1,1,2-tetrafluoroethane (99%), Pentafluoroethane (99%), and 1,1,1,2,3,3,3-Heptafluoropropane (98%) may be used. The salts Lithium bis(fluorosulfonyl)imide (LiFSI) (99.9%) and lithium bis(trifluoromethane)sulfonimide (LiTFSI) (99.9%) may also be used. 1M LiPF₆ in EC/EMC 3:7 was obtained from BASF. 1,2-dimethoxyethane (DME, 99.5%) may be used and stored over molecular sieves. The NMC622 (A-C023) may also be used.

### Electrochemical Measurements

Electrolytic conductivity measurements were performed in custom fabricated high-pressure stainless-steel coin cells, using polished stainless-steel (SS 316L) as both electrodes. The cell constant was calibrated frequently from 0.447 to 80 mS cm⁻¹ by using OAKTON standard conductivity solutions.

The Li⁺ transference number is measured by the potentiostatic polarization method with an applied voltage of 5 mV. There are two lithium metal sandwiching 500-micron glass fiber during tests. Electrochemical impedance spectroscopy was collected by a Biologic SAS (SP-200) system and the spectra were then fitted using software.

Battery cycling test was performed using a battery test station. Li metal (1 mm thickness, ⅜-inch diameter) and a polished SS316L were used as the counter electrode and the working electrode, respectively. A single 25 μm porous polypropylene separator was used for all the electrochemical tests.

For Li metal plating and stripping experiments, lithium was first deposited onto the working electrode at 0.5 mA cm⁻² until 0 V vs. Li and the voltage was held for 5 hours to form a stable SEI on the current collector. The first plating cycle was then started, followed by complete lithium stripping to a 1 V vs. Li cut off voltage. The CE was calculated as the Li stripping capacity divided by the Li plating capacity during each single cycle. For the test in different temperatures, the cells were soaked at the testing temperature in a temperature chamber (Espec) for several hours before cycling. In Li-NMC cycling, the cell was firstly cycled at C/10 rate at room temperature for 2 activation cycles and then cycled at selected rate and temperature.

### Material Characterization

The pressure measurements of different pure gases or formulated LGE are performed in a Honeywell FP5000 pressure sensor from −40 to +60° C.

Lithium metal soak tests are performed in a custom-built stainless-steel cell withstanding up to 2000 psi. All of lithium metals are soaked in the corresponding electrolytes for half months. The optical images were taken after dissembled soak cells.

Fire extinguishing experiments are conducted in a fume hood with the following fixed parameters: gas flow at 150 standard cubic centimeters per minute (SCCM), relative height and distance of safety cell and candle, and an open system within the fume hood. The experiments are set up with a safety cell connected to a mass flow controller (MFC) and a stainless-steel tube with a valve for precise control of the gas flow. The cell serves to separate the gas tanks from the ignited candle for a safe operating environment. A constant gas flow is maintained by the MFC while the relative height and distance between the cell and candle are maintained with two utility clamps. Subsequently, various gas types are utilized in this experimental setup to demonstrate their fire extinguishing efficacy.

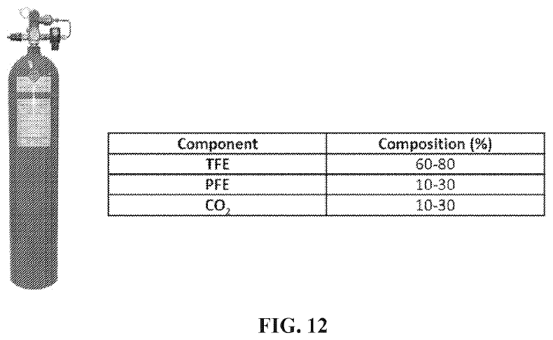

FIG. 12 shows the compositions of clean agent of FS 49 C2.

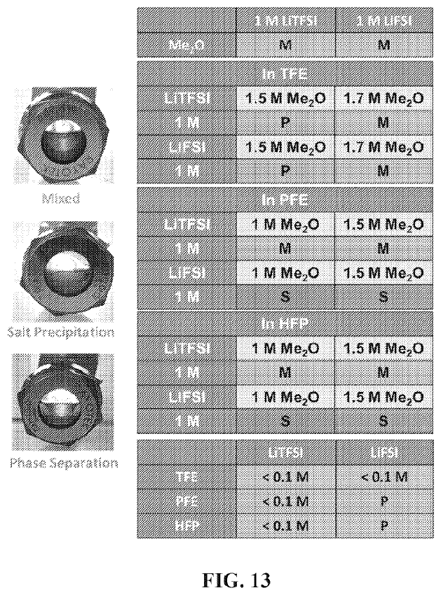

FIG. 13 shows solubility test on LiTFSI/LiFSI-Me₂O-TFE/PFE/HFP and pure Me₂O/TFE/HFP.

FIGS. 14A-14D show solubility test on 1 MLiFSI-Me₂O-TFE-PFE at different temperature (FIG. 14A) +23° C. (FIG. 14B) +60° C. and (FIG. 14C) −78° C. FIG. 14D shows tailor Me₂O ratio to fully dissolve LiFSI at +23° C.

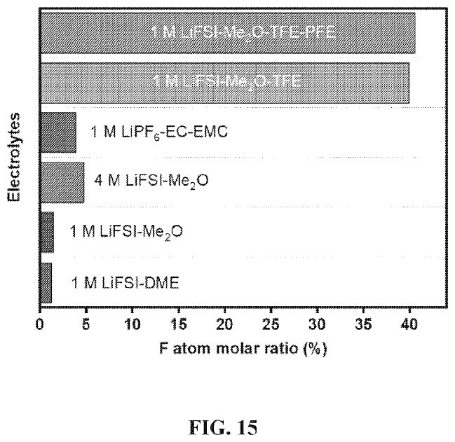

FIG. 15 shows fluorine atom molar ratio in different electrolytes.

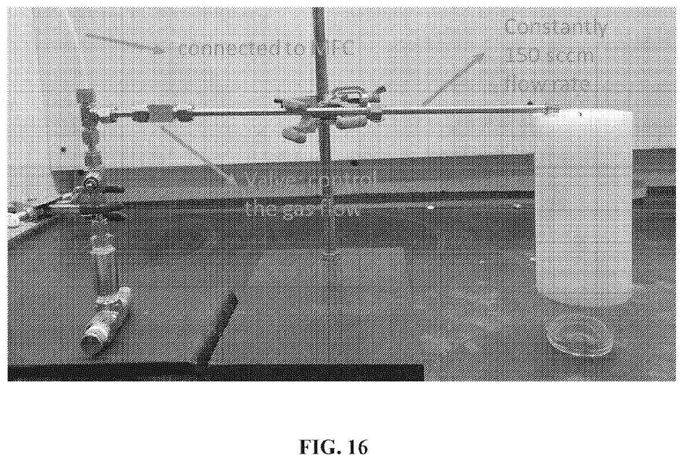

FIG. 16 shows device setup for candle tests. The flow rate is controlled by mass flow control (MFC) to constantly release 150 sccm flow rate of different gases.

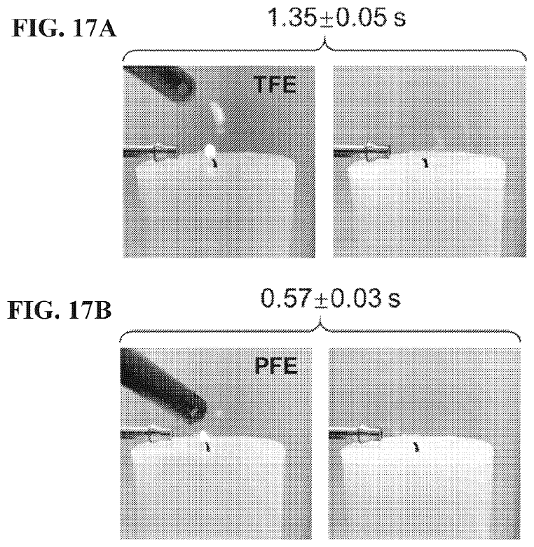

FIGS. 17A-17B show fire suppression tests of different pure gases (FIG. 17A) TFE and (FIG. 17B) PFE.

FIG. 18 shows optical images of lithium metals soaked in liquefied gas solvents and electrolytes for 14 days.

FIG. 19 shows Li-NMC622 voltage hold test in the liquefied gas electrolytes.

FIG. 20 shows long-term Li/NMC cycling at +55° C.

FIG. 21 shows transference number measurement of designed electrolyte.

FIG. 22 shows Li/NMC cycling at different current rate.

FIG. 23 shows summary of the global warming potential for different gases. Data are extracted from IPCC Second Assessment Report.

Clean Agent FS 49 C2 (FIG. 12) is a clean fire extinguishing gas mixture that effectively suppresses fires while sustaining breathable concentrations of oxygen in the air. Furthermore, it is environmentally friendly with components of TFE and PFE characterized by an Ozone Depletion Potential (ODP) of 0.

A series of salt solubility tests were performed to check the salt dissolution in different solvents or their mixtures (FIG. 13). 1 M LiTFSI/LiFSI can immediately dissolved in Me₂O. When mixed with TFE, both LiTFSI and LiFSI can formulate a solution with maximum 1:1.7 salt: Me₂O ratio. When switched to PFE or 1,1,1,2,3,3,3-Heptafluoropropane (HFP), LiFSI systems will observe phase separations. By comparison, LiTFSI can obtain a well dissolved solution with maximum 1:1 salt: Me₂O ratio. This can be explained by the lower bond dissociation energy of LiTFSI over LiFSI, which makes LiTFSI more dissolvable. Interestingly, these principles are verified for LiTFSI in pure PFE and HFP system. Both of them can dissolve less than 0.1 M LiTFSI, however, they cannot well mix with LiFSI. TFE can dissolve less than 0.1 M LiTFSI or LiFSI.

Li metal soak tests were performed to check the compatibility of liquefied gas solvents and electrolytes (FIG. 18). After soaking Li metal for half month, the Li metals in TFE or PFE maintained their shape but decolored, indicating moderate compatibility with Li metal. The compatibility for Me₂O is improved in comparison to TFE and PFE. For the 1 M LiFSI-Me₂O, 1 M LiFSI-Me₂O-TFE and 1 M LiFSI-Me₂O-TFE-PFE electrolytes, the Li metals retained a clean and shinning appearance due to the formed favorable interface.

### Using Dimethyl Ether (Me₂O) as Salt Recovery Carrier

The disclosed technology can be implemented in some embodiments to use dimethyl ether (Me₂O), which exists at gaseous state at standard temperature and pressure (STP) conditions (boiling point: −28° C. at STP) as a liquefied gas solvent for enabling next-generation lithium-ion batteries due to its superior physical properties and excellent lithium metal compatibility. Distinct to hydrofluorocarbon-based liquefied gas solvents, Me₂O exhibits the highest solubility of different Li-salts due to the small molecular size and ether functional group. Given the propensity of Me₂O to solvate the Li⁺ ion, the high covalency of Li⁺ and the high interaction energy of Li⁺ and ether oxygen in the Me₂O molecule, Li salts are expected to hold the dimethyl ether solvent even at near atmospheric pressures.

The above-mentioned concept can be applied for the recovery of electrolyte salts used in lithium-ion batteries, e.g., Lithium hexafluorophosphate (LiPF₆), Lithium bis(fluorosulfonyl)imide (LiFSI), Lithium bis(trifluoromethanesulfonyl)imide (LiTFSI), and other types of Lithium salts as salt or additives used in lithium contained batteries/energy storage devices (hereinafter referred to as “Li—X”) from the spent battery or manufacturing scraps. The sub-zero boiling point of Me₂O can also facilitate easy recovery of high purity salt from the feed solution with a low power vacuum crystallizer. Non-toxicity and easy recyclability of Me₂O has a positive impact on the environment as well.

### Development of Li—X/Me₂O Solution With Vapor Pressure (Pᵥₐₚ) at About 1 Atm

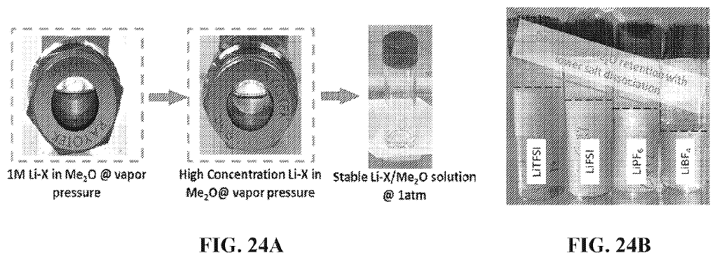

FIGS. 24A-24B show stable Li—X/Me₂O (X=FSI⁻/TFSI⁻/PF₆⁻/any anion) solvent preparation with Pᵥₐₚ at about 1 atm.

To develop a stable Li—X/Me₂O solution with Pᵥₐₚ at about 1 atm, 1M Li—X salt solution is prepared in a high-pressure window cell (FIG. 24A) by filling Me₂O gas at dry ice condition. The concentration of the solution increases as the pressure of the system is decreased by slowly releasing Me₂O gas from the cell. Once the gas is released completely, the equilibrium of the solution is reached at atmospheric pressure, as shown in FIG. 24A.

In some implementations, salts with high ion-pair dissociation can be observed to have more Me₂O retention with the decrease trend from LiTFSI, LiFSI, LiPF₆ to LiBF₄ (FIG. 24B). The as-obtained Li—X/Me₂O solutions have more than 5 M of salt concentration.

### Investigation of Battery Salt Holding Capacity at Ambient Conditions

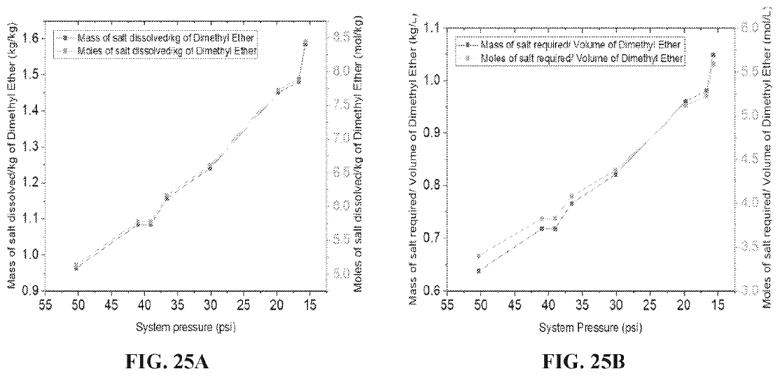

FIGS. 25A-25B show salt recovery curves of LiFSI in Me₂O based on mass (FIG. 25A) and based on volume (FIG. 25B).

The Li—X from used battery materials can be recollected and recovered using liquefied dimethyl ether. The specific salt dissolving mass in the Me₂O solution varies with the pressure. Due to the easiness of processibility, a lower operating pressure less than 20 psi is preferrable.

The relationship between operating pressures and the mass of salt dissolved in the 1 kg Me₂O is shown in FIGS. 25A-25B. LiFSI is used as the investigated salt in the Me₂O-based solutions at different temperatures. 3M LiFSI/Me₂O solution is prepared and added to a sealing stainless steel container with sight glass for the demonstration tests. Initially, the solution is at 3 M salt concentration with vapor pressure around 50 psi. As extra gaseous Me₂O vented from the sight glass cell, the change of the mass and the volume of the solution is recorded. When the pressure reaches to ˜15 psi (close to ambient pressure), the equilibrium salt concentration was found to be ˜8.5 mol/kg (FIG. 25A) or ˜5.5 mol/L (FIG. 25B), corresponding to about 1.6 kg of LiFSI salt/kg of Me₂O and about 1.05 kg of LiFSI salt/L of Me₂O.

### Li—X Salt Recovery Cycle

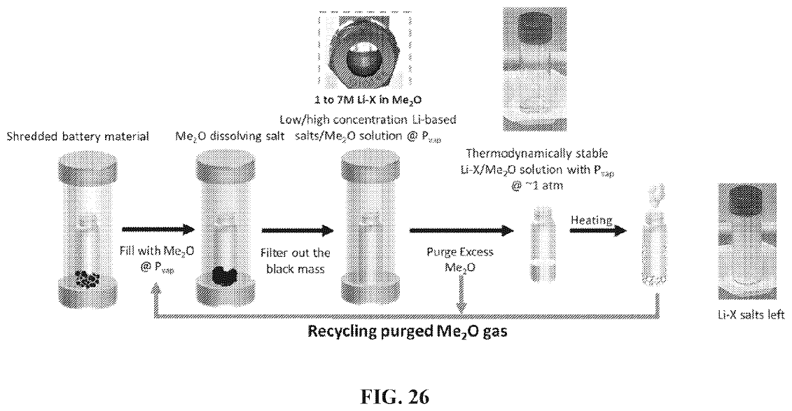

FIG. 26 shows an example of salt recovery circular system. The shredded battery and/or black mass is washed with Me₂O to dissolve only salt. The washed battery shreds and/or black mass is filtered to obtain the feed solution for salt recovery. The solution is moved to recovery unit, where the salt is recovered by heating the solution and the solvent (Me₂O) can be easily recycled owing to the very low latent heat of vaporization −21.510 kJ/mol at 248.34K at 1 atm. Using liquified gas as a solvent for salt recovery may not only reduce the battery recycling risk but also can generate profit in efficient recycling methods.

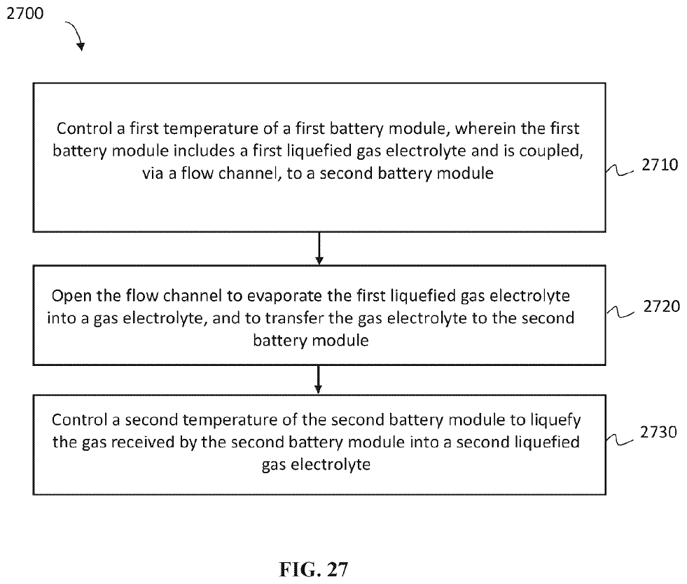

FIG. 27 shows an example method 2700 for solvent recycling based on some implementations of the disclosed technology.

In some implementations of the disclosed technology, the method 2700 may include, at 2710, controlling a first temperature of a first battery module, wherein the first battery module includes a first liquefied gas electrolyte and is coupled, via a flow channel, to a second battery module, at 2720, opening the flow channel to evaporate the first liquefied gas electrolyte into a gas electrolyte, and to transfer the gas electrolyte to the second battery module, and at 2730, controlling a second temperature of the second battery module to liquefy the gas received by the second battery module into a second liquefied gas electrolyte.

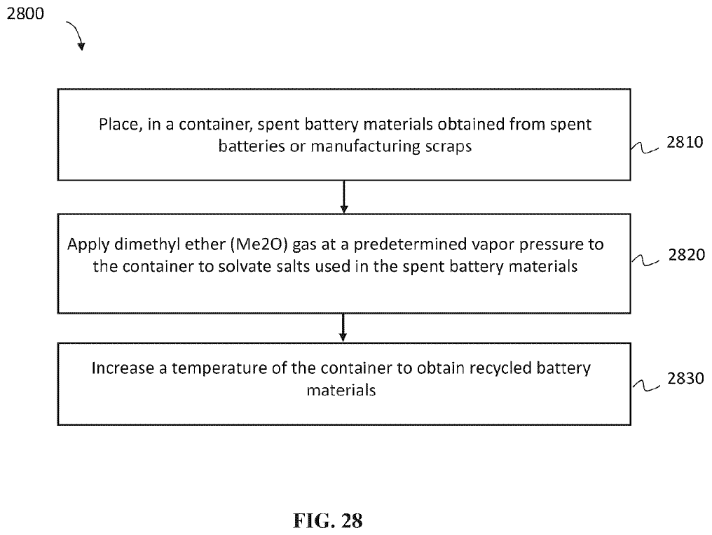

FIG. 28 shows an example method 2800 of recycling electrolyte salts for lithium-ion batteries based on some implementations of the disclosed technology.

In some implementations of the disclosed technology, the method 2800 may include, at 2810, placing, in a container, spent battery materials obtained from spent batteries or manufacturing scraps, at 2820, applying dimethyl ether (Me₂O) gas at a predetermined vapor pressure to the container to solvate salts used in the spent battery materials, and at 2830, increasing a temperature of the container to obtain recycled battery materials.

Therefore, various implementations of features of the disclosed technology can be made based on the above disclosure, including the examples listed below.

Example 1. A device, comprising: a first battery module including a first liquefied gas electrolyte; a second battery module structured to store a second liquefied gas electrolyte; a temperature controller coupled to the first battery module and to the second battery module and configured to separately control a first temperature of the first battery module and a second temperature of the second battery module to allow evaporation of the first liquefied gas electrolyte into a gas electrolyte and liquefication of the gas into the second liquefied gas electrolyte; and a flow channel coupled between the first battery module and the second battery module to convey the gas electrolyte from the first battery module to the second battery module.

Example 2. The device of example 1, comprising: a mass flow controller coupled to the flow channel to control a flow of the gas electrolyte from the first battery module to the second battery module.

Example 3. The device of example 2, wherein the mass flow controller is configured to open the flow channel to: evaporate the first liquefied gas electrolyte; transfer the evaporated first liquefied gas electrolyte to the second battery module; and liquefy the evaporated first liquefied gas electrolyte into the second liquefied gas electrolyte to be stored in the second battery module.

Example 4. The device of any of examples 1-3, wherein the first battery module includes spent liquefied gas electrolytes.

Example 5. The device of any of examples 1-3, wherein the second battery module includes an empty space to accommodate the second liquefied gas electrolyte.

Example 6. The device of any of examples 1-3, wherein the first temperature is higher than the second temperature to create a pressure difference between the first battery module and the second battery module.

Example 7. The device of any of examples 1-3, wherein the first liquefied gas electrolyte includes spent liquefied gas solvent molecules, and the second liquefied gas electrolyte includes liquefied gas solvent molecules converted from the spent liquefied gas solvent molecules for reuse.

Example 8. The device of any of examples 1-3, wherein the first liquefied gas electrolyte includes dimethyl ether (Me₂O).

Example 9. The device of any of examples 1-3, wherein the first liquefied gas electrolyte includes a fire-extinguishing solvent.

Example 10. The device of example 9, wherein the fire-extinguishing solvent includes dimethyl ether (Me₂O).

Example 11. The device of example 10, wherein the fire-extinguishing solvent further includes at least one of tetrafluoroethane (TFE) and pentafluoroethane (PFE).

Example 12. The device of example 11, wherein the first liquefied gas electrolyte includes at least one of lithium bis(fluorosulfonyl)imide (LiFSI) or lithium bis(trifluoromethanesulfonyl)imide (LiTFSI).

Example 13. A recycling method, comprising: controlling a first temperature of a first battery module, wherein the first battery module includes a first liquefied gas electrolyte and is coupled, via a flow channel, to a second battery module; opening the flow channel to evaporate the first liquefied gas electrolyte into a gas electrolyte, and to transfer the gas electrolyte to the second battery module; and controlling a second temperature of the second battery module to liquefy the gas received by the second battery module into a second liquefied gas electrolyte.

Example 14. The method of example 13, comprising creating a pressure difference between the first battery module and the second battery module by controlling the first temperature to be higher than the second temperature.

Example 15. The method of example 13, wherein the first liquefied gas electrolyte includes spent liquefied gas solvent molecules, and the second liquefied gas electrolyte includes liquefied gas solvent molecules converted from the spent liquefied gas solvent molecules for reuse.

Example 16. A method of recycling electrolyte salts for lithium-ion batteries, comprising: placing, in a container, spent battery materials obtained from spent batteries or manufacturing scraps; applying dimethyl ether (Me₂O) gas at a predetermined vapor pressure to the container to solvate salts used in the spent battery materials; and increasing a temperature of the container to obtain recycled battery materials.

Example 17. The method of example 16, wherein the used battery materials include lithium salts.

Example 18. The method of example 17, wherein the lithium salts include at least one of lithium hexafluorophosphate (LiPF₆), lithium bis(fluorosulfonyl)imide (LiFSI), or lithium bis(trifluoromethanesulfonyl)imide (LiTFSI).

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the singular forms “a”, “an” and “the” are intended to include the plural forms as well, unless the context clearly indicates otherwise. Additionally, the use of “or” is intended to include “and/or”, unless the context clearly indicates otherwise.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A device, comprising:
a first battery module including a first liquefied gas electrolyte;
a second battery module structured to store a second liquefied gas electrolyte;
a temperature controller coupled to the first battery module and to the second battery module and configured to separately control a first temperature of the first battery module and a second temperature of the second battery module to allow evaporation of the first liquefied gas electrolyte into a gas electrolyte and liquefication of the gas into the second liquefied gas electrolyte; and
a flow channel coupled between the first battery module and the second battery module to convey the gas electrolyte from the first battery module to the second battery module.

2. The device of claim 1, comprising:
a mass flow controller coupled to the flow channel to control a flow of the gas electrolyte from the first battery module to the second battery module.

3. The device of claim 2, wherein the mass flow controller is configured to open the flow channel to: evaporate the first liquefied gas electrolyte; transfer the evaporated first liquefied gas electrolyte to the second battery module; and liquefy the evaporated first liquefied gas electrolyte into the second liquefied gas electrolyte to be stored in the second battery module.

4. The device of claim 1, wherein the first battery module includes spent liquefied gas electrolytes.

5. The device of claim 1, wherein the second battery module includes an empty space to accommodate the second liquefied gas electrolyte.

6. The device of claim 1, wherein the first temperature is higher than the second temperature to create a pressure difference between the first battery module and the second battery module.

7. The device of claim 1, wherein the first liquefied gas electrolyte includes spent liquefied gas solvent molecules, and the second liquefied gas electrolyte includes liquefied gas solvent molecules converted from the spent liquefied gas solvent molecules for reuse.

8. The device of claim 1, wherein the first liquefied gas electrolyte includes dimethyl ether (Me₂O).

9. The device of claim 1, wherein the first liquefied gas electrolyte includes a fire-extinguishing solvent.

10. The device of claim 9, wherein the fire-extinguishing solvent includes dimethyl ether (Me₂O).

11. The device of claim 10, wherein the fire-extinguishing solvent further includes at least one of tetrafluoroethane (TFE) and pentafluoroethane (PFE).

12. The device of claim 11, wherein the first liquefied gas electrolyte includes at least one of lithium bis(fluorosulfonyl)imide (LiFSI) or lithium bis(trifluoromethanesulfonyl)imide (LiTFSI).

13. A recycling method, comprising:
controlling a first temperature of a first battery module, wherein the first battery module includes a first liquefied gas electrolyte and is coupled, via a flow channel, to a second battery module;
opening the flow channel to evaporate the first liquefied gas electrolyte into a gas electrolyte, and to transfer the gas electrolyte to the second battery module; and
controlling a second temperature of the second battery module to liquefy the gas received by the second battery module into a second liquefied gas electrolyte.

14. The method of claim 13, comprising creating a pressure difference between the first battery module and the second battery module by controlling the first temperature to be higher than the second temperature.

15. The method of claim 13, wherein the first liquefied gas electrolyte includes spent liquefied gas solvent molecules, and the second liquefied gas electrolyte includes liquefied gas solvent molecules converted from the spent liquefied gas solvent molecules for reuse.

16. A method of recycling electrolyte salts for lithium-ion batteries, comprising:
placing, in a container, spent battery materials obtained from spent batteries or manufacturing scraps;
applying dimethyl ether (Me₂O) gas at a predetermined vapor pressure to the container to solvate salts used in the spent battery materials; and
increasing a temperature of the container to obtain recycled battery materials.

17. The method of claim 16, wherein the used battery materials include lithium salts.

18. The method of claim 17, wherein the lithium salts include at least one of lithium hexafluorophosphate (LiPF₆), lithium bis(fluorosulfonyl)imide (LiFSI), or lithium bis(trifluoromethanesulfonyl)imide (LiTFSI).
